(19) United States
(12) Patent Application Publication
(10) Pub. No.: US 2012/0227466 A1
(43) Pub. Date: Sep. 13, 2012

(54) METHODS FOR DETECTION OF ACETYLENE ON BIMETALLIC SENSORS

(76) Inventors: James William Medlin, Boulder, CO (US); Kristi L. Miller, Eagle, CO (US); Stephen Marshall, Bartlesville, OK (US)

(21) Appl. No.: 13/417,085

(22) Filed: Mar. 9, 2012

Related U.S. Application Data
(60) Provisional application No. 61/451,726, filed on Mar. 11, 2011.

(51) Int. Cl. G01N 7/00

(52) U.S. Cl. 73/31.06; 73/23.2

(57) ABSTRACT

Methods for detection of acetylene, acetylene concentration and changes in acetylene concentration in a mixture of gases are provided. The gas mixture includes acetylene and hydrogen and may be a hydrogen gas stream or a gas stream also including ethylene. The methods of the invention can also detect acetylene in a gas mixture dissolved in a liquid. The methods of the invention rely on the use of metal-insulator-semiconductor (MIS) sensors in which the metal layer is a continuous layer of a binary alloy selected to facilitate acetylene detection such as alloys of palladium with a second metal such as silver, gold or copper.

### CROSS-REFERENCE TO RELATED APPLICATIONS

This application claims the benefit of U.S. Provisional Application No. 61/451,726, filed Mar. 11, 2011, which is hereby incorporated by reference in its entirety.

### BACKGROUND

Real-time detection of hydrogen (H₂) and other gases is important in various industrial settings. The detection of gases dissolved in liquids is also an important problem for many applications. (Hedborg, E.; Winquist, F.; Lundstrom, I.; Andersson, L. I.; Mosbach, K., Some studies of molecularly-imprinted polymer membranes in combination with field-effect devices, Sens. Actuators A 1993, 37-8, 796). For example, faults may occur when oil-filled electrical equipment is subjected to thermal or electrical stresses, which break down the oil and generate “fault gases”.

Previous work has proven that solid-state metal-insulator-semiconductor (MIS) sensors that are highly responsive to H₂ can be reproducibly prepared. For example, MIS sensors are capable of detecting H₂ concentrations in the parts per billion range. These sensors are typically prepared by depositing a film of catalytic metal onto a thin layer of gate insulator material that has been grown on a semiconductor substrate. If the insulator is silicon dioxide, these sensors may also be termed metal-silicon dioxide-semiconductor (MOS) or thin-film metal-silicon dioxide-semiconductor (TMOS) sensors. Catalytic metals which have been used in hydrogen sensitive MIS sensors include Pd, Pt, and Pd/Ag alloys (Lundstrom, I., Hydrogen Sensitive Mos-Structures: 1. Principles and Applications. Sens. Actuators, 1981. 1: p. 403-426, R. C. Hughes, W. K. Schubert, T. E. Zipperian, J. L. Rodriguez, and T. A. Plut, J. Appl. Phys. 62 (1987) 1074).

The basic H₂ sensing mechanism for MIS devices has been described in pioneering works by Lundström and coworkers. To provide a brief description, gas-phase H₂ dissociates on the surface of the catalytic metal to form H atoms. These H atoms then rapidly diffuse through the metal film to the metal-insulator interface, where they are preferentially trapped in stabilized adsorption sites. The layer of interfacial hydrogen created by this process exists in a dipole layer, creating an additional voltage drop across the MIS sensor that can be measured as either a voltage shift in the capacitance-voltage (C-V) curve of a capacitor, or in the current-voltage characteristic of a diode or transistor.

Previous work has tested the response of MIS devices with continuous Pd gate layers to acetylene. MIS devices with pure Pd gates did not produce a statistically significant response to acetylene in a hydrogen background at 50° C. [5]. A response was detected for acetylene in a carrier gas of 20% O₂ in N₂ for MIS sensors (Pd film 100 nm thick) operated at 120-210° C.; this response was characterized as small [28].

### SUMMARY

Acetylene detection in a hydrogen background is important in several applications including acetylene contamination in ethylene streams for polyethylene production [5, 6, 23] and in fault gases in transformers [2]. In one aspect, the present invention provides methods for detection of acetylene in a mixture of gases, where the gas mixture includes acetylene and hydrogen. The gas mixture may be a hydrogen gas stream or a gas stream also including ethylene. The methods of the invention can also detect acetylene dissolved in a liquid. For example, the sensors of the invention are capable of detecting acetylene in a mixture of acetylene and hydrogen dissolved in oil or a solvent.

The methods of the invention rely on the use of metal-insulator-semiconductor (MIS) sensors in which the metal layer is a continuous layer of a binary alloy selected to facilitate acetylene detection. Useful catalytic metals for such MIS sensors include alloys of palladium with a second metal. The second metal may be Ag or may be selected from the group consisting of Ag, Au, and Cu. The average weight percentage of the second metal in the palladium alloy may be 5%-50%, 10%-40%, 10%-30%, 10%-25%, 10%-20%, or 20-40%. In an embodiment, the MIS sensor comprises a first layer of a semiconducting material; a second layer of an inorganic insulating material attached to the semiconducting layer; a third layer of a binary metal alloy attached to the layer of the inorganic insulating material; a first conductor connected to the first layer; and a second conductor connected to the third layer, wherein the binary metal alloy is Pd—Ag or is selected from the group consisting of Pd—Ag, Pd—Au, and Pd—Cu. The MIS sensor may optionally include a selective layer shielding the metal layer from the environment, with the selective layer being chosen to limit diffusion of molecules larger than acetylene through the layer.

MIS sensors useful for detecting acetylene in combination with hydrogen are sensitive or responsive to both acetylene and hydrogen. The sensor response to a combination of acetylene and hydrogen, when compared to the sensor response to an equivalent concentration of hydrogen, produces either a voltage shift in the capacitance-voltage (C-V) curve of a capacitor, or in the current-voltage characteristic of a diode or transistor, depending on the configuration of the sensor. The response of the sensor to the environment is detected by measuring the relevant voltage shift or current-voltage characteristics. For example, a capacitor-type sensor may respond to the presence of hydrogen by showing a decrease in bias voltage (due to the presence of hydrogen at the metal-insulator interface). It has been found that adding acetylene to the mixture (while retaining the same concentration of hydrogen) can lead to an increase in signal to a more positive bias voltage (due to acetylene consuming hydrogen through a surface hydrogenation reaction that lowers the steady state concentration of interfacial hydrogen) (see Example 1). In different embodiments, palladium-alloy sensors useful for acetylene detection can produce a shift in bias voltage of at least 1 mV, at least 2 mV, from 1-50 mV, from 1-25 mV, from 2-50 mV or from 2-25 mV for a 100 ppm change in acetylene concentration. In an embodiment, these bias voltage shifts may be seen obtained for a constant hydrogen concentration and for an acetylene concentration less than 1000 ppm.

In an embodiment, the invention provides a method for determining the presence of acetylene in a gas mixture or a liquid solution comprising hydrogen, the method comprising the steps of: providing a metal-insulator-semiconductor sensor including a continuous palladium alloy layer and first and a second conductor; providing a signal processing device in electrical communication with the first and second conductors of the MIS sensor; providing a calibration signal to the signal processing device; exposing the sensor to the gas mixture or liquid solution, thereby generating an electrical signal; providing the electrical signal to the signal processing device; and determining the presence of acetylene by comparing the calibration signal to the signal generated when the sensor was exposed to the gas mixture or liquid solution. The calibration signal indicates the sensor's response to a hydrogen-containing gas mixture that is free of acetylene, and may be obtained by exposing a second (calibration) sensor to the gas mixture or liquid solution, the second sensor being selected so that it is not responsive to acetylene. Variation in the signal output between the calibration signal and the signal can be used to indicate the presence of acetylene in the hydrogen-containing gas mixture or liquid solution. The amount of variation can also quantitatively determine the amount of acetylene. The methods of the invention may also be used to determine changes in acetylene concentration.

In an embodiment, the invention provides a method for detecting the presence of acetylene in a gas mixture or a liquid solution comprising at least 1 ppm hydrogen, the method comprising the steps of:
a. providing a first sensor sensitive to hydrogen and acetylene, the sensor being a metal-insulator-semiconductor sensor including a continuous palladium alloy layer;
b. providing a second sensor (reference sensor) sensitive to hydrogen and not sensitive to acetylene;
c. providing a signal processing device in electrical communication with the first and second sensors;
d. generating an first electrical signal by exposing the first sensor to the gas mixture or liquid solution, the first sensor being maintained at a selected temperature;
e. generating an second electrical signal by exposing the second sensor to the gas mixture or liquid solution, the second sensor being maintained at the selected temperature;
f. detecting the presence of acetylene through comparing the first and second electrical signals using the signal processing device.

In another embodiment, the invention provides a method for determining the concentration of acetylene in a gas mixture or a liquid solution comprising at least 1 ppm hydrogen, the method comprising the steps of:
a. providing a first sensor sensitive to hydrogen and acetylene, the sensor being a metal-insulator-semiconductor sensor including a continuous palladium alloy layer;
b. providing a second sensor (reference sensor) sensitive to hydrogen and not sensitive to acetylene;
c. providing a signal processing device in electrical communication with the first and second sensors;
d. generating an first electrical signal by exposing the first sensor to the gas mixture or liquid solution, the first sensor being maintained at a selected temperature;
e. generating an second electrical signal by exposing the second sensor to the gas mixture or liquid solution, the second sensor being maintained at the selected temperature;
f. determining the hydrogen concentration in the gas mixture or liquid solution using the signal processing device and a predetermined relationship between the second electrical signal and hydrogen concentration; and
g. determining the concentration of acetylene in the gas mixture or liquid solution using the signal processing device and a predetermined relationship between the first signal and the acetylene concentration for the hydrogen concentration determined in step f).

In an embodiment, the metal-insulator-semiconductor sensor is a capacitance sensor comprising a layer of the insulating material, a layer of the palladium alloy attached to one side of the layer of the insulating material and a layer of the semiconducting material attached to the other side of the layer of the insulating material and the electrical signal provided to the signal processing device is the voltage to maintain a constant capacitance. In another embodiment, metal-insulator semiconductor sensor is a diode sensor comprising a layer of the insulating material, a layer of the palladium alloy attached to one side of the layer of the insulating material and a layer of the semiconducting material attached to the other side of the layer of the insulating material and the electrical signal provided to the signal processing device is the current between the metal and the semiconductor layers. In yet another embodiment, the metal-insulator semiconductor sensor is a transistor sensor comprising a layer of the insulating material, a layer of the palladium alloy attached to one side of the layer of the insulating material and a layer of the semiconducting material attached to the other side of the layer of the insulating material, the layer of the semiconducting material including source and drain regions and the electrical signal provided to the signal processing device is the current between the source and drain regions.

Other gases may not be directly detected by the sensor, but can influence the response of the sensor to hydrogen. For example, carbon monoxide can affect the response of the sensor to hydrogen and other gases through strong competitive adsorption on the catalytic metal surface. As another example, oxygen can affect the response of the sensor to hydrogen through water forming reactions. Water forming reactions between adsorbed H and O on the catalytic metal surface can consume H, leading to a substantially decreased sensor response. In an embodiment, acetylene detection may be performed in an environment where the concentration of other gases (than hydrogen or acetylene) capable of influencing the response of the sensor is low enough that the sensor response is not significantly affected. In another embodiment, acetylene detection may be performed in an environment where the concentration of other gases (than hydrogen or acetylene) capable of influencing the response of the sensor is essentially constant over the time period of detection (e.g. detection may be performed in an air environment where the concentration of oxygen is essentially constant). In an embodiment, both the first and the second sensor are sensitive to oxygen.

In the methods of the invention, the temperature of the MIS sensor may be from 20° C. to 400° C., 20° C. to 200° C., 20° C. to 125° C., 20° C. to 100° C., 50° C. to 400° C., 50° C. to 200° C., 50° C. to 125° C. or 50° C. to 100° C. In an embodiment, the concentration of acetylene may be from 1 to 1000 ppm.

### BRIEF DESCRIPTION OF THE FIGURES

FIG. 1: Basic structure and hydrogen surface chemistry for a metal-insulator-semiconductor (MIS) sensor.

FIG. 2. Response on Pd at 398 K to repeated acetylene doses at 100 ppm. The solid line is acetylene addition and dashed line is acetylene removal.

FIG. 3. Response on 15% Ag/Pd at 398 K to repeated acetylene doses at 100 ppm. The solid line is acetylene addition and dashed line is acetylene removal. The inset shows response to 500 ppm hydrogen at 398 K, and the solid line is when hydrogen was added.

FIG. 4. Sensor response to 100 ppm acetylene on 5, 15, and 40% Ag/Pd sensors at 323, 348, and 398 K.

FIG. 5. Response on 15% Cu/Pd at 398 K to repeated acetylene doses at 100 ppm. The solid line is acetylene addition and dashed line is acetylene removal.

FIG. 6. Overshoot of sensor response on 15% Ag/Pd at 348 K plotted with hydrogen consumption rate from kinetic model on Pd₅₀Ag₅₀ at 348 K.

FIG. 7. H(i) difference between 100 ppm C₂H₂ and pure H₂ feed as a function of temperature on (▪) Pd₅₀Ag₅₀ (dotted line), and () Pd (solid line).

FIG. 8. Comparison of hydrogen consumption rate from kinetic model to experimental sensor response. Solid line connects hydrogen consumption rate vs. temperature calculated from kinetic model for Pd₅₀Ag₅₀ and Pd at 100 ppm acetylene feed for (▪) Pd₅₀Ag₅₀; () Pd. Dotted lines connect experimental sensor response vs. temperature (▴) 40% Ag/Pd; () 15% Ag/Pd; and (♦) 5% Ag/Pd.

FIG. 9. Carbon species formed on (▪) Pd₅₀Ag₅₀ and () Pd surfaces. CCH(s) is depicted by dashed line, CH(s) is depicted by dashed-dotted line, C(s) is depicted by dotted line, and C₂H₂(s) is depicted by the solid line.

### DETAILED DESCRIPTION

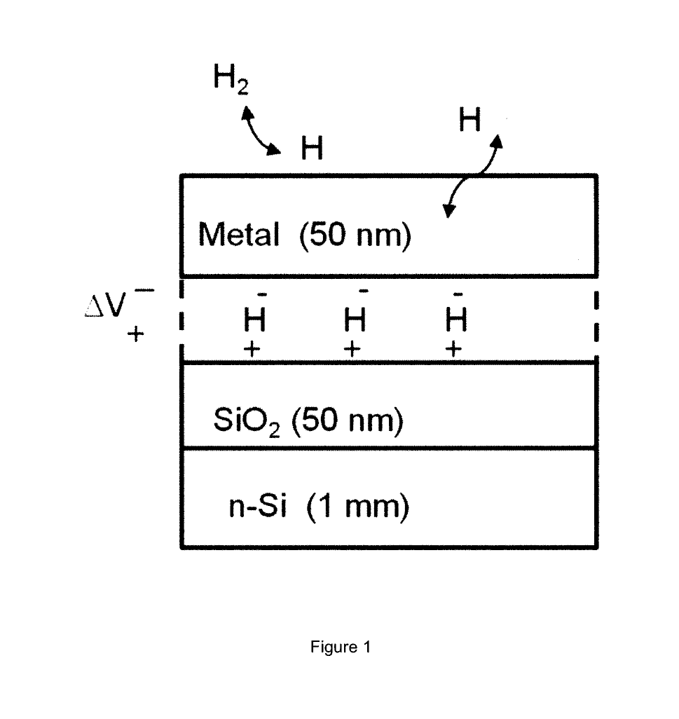

In general, MIS sensors comprise a layer of a semiconducting material, a layer of an insulating material attached to the semiconducting layer and a layer of metal attached to the insulating layer. The layer of insulating material is typically “sandwiched” between the semiconducting and metal layers, with the semiconducting and metal layers being attached to opposite faces of the insulating layer. FIG. 1 schematically illustrates a capacitance-type MIS sensor with an n-silicon semiconducting layer, a silicon dioxide insulating layer, and a metal layer. A layer of hydrogen at the metal-insulator interface formed by diffusion of hydrogen through the metal layer is also schematically shown between the metal and oxide layers. An electrical contact is typically made to the semiconductor layer and to the metal layer; methods for making such contacts are known to the art. For example, the bottom surface of the semiconductor layer (opposite the surface in contact with the insulating layer) may be metallized to form a contact.

Useful metals for acetylene detection with MIS sensors include alloys of palladium with a second metal. The second metal may be Ag or may be selected from the group consisting of Ag, Au, Cu and Ni. In different embodiments, the average weight percentage of the second metal in the alloy is 5%-50%, 10%-40%, 10%-30%, 10%-25% 10%-20%, or 20-40%. The surface composition of the second metal may be different than this average composition. For example, it has been reported that silver segregates to the surface of Ag/Pd, for example to over 90% when the bulk composition is 33% Ag [31, 32]. The addition of H₂ may reduce this surface segregation, [31] so the actual Ag percentage at the sensor surface under reaction conditions may be unknown. In different embodiments, the combination of the first and the second metal makes up at least 95%, 98% or 99% of the alloy. The metal films may be oxidized after exposure to air, but the films are typically reduced before and/or during operation. The thickness of the metal layer may be from 10 nm to 5000 nm, from 20 nm to 2000 nm, or from 10 to 500 nm. In an embodiment, the metal layer is dense or continuous and does not contain cracks or pores. The metal layer may be deposited by any means known to the art, including, but not limited to, evaporation (thermal or electron beam) or sputter deposition. In an embodiment, deposition occurs under vacuum.

Any inorganic electrically insulating material known to the art can be used for the insulator layer. In an embodiment, the insulating material is an oxide material such as silicon dioxide. In another embodiment, a plurality of insulator layers may be used. For example, a thin secondary insulating layer, such as silicon nitride, may be located in between the primary insulating layer and the catalytic metal layer. In different embodiments, the thickness of the primary insulating layer may be from 1 nm to 500 nm, 1 to 100 nm, 2 to 100 nm, 10 nm to 100 nm, or 2 nm to 75 nm. The thickness of the secondary insulating layer (if present) may be from 1 nm to 300 nm or 1 nm to 50 nm. Any semiconducting material known to the art can be used for the semiconducting layer. This layer may function as a substrate for the sensor. The semiconducting layer may be doped. If the sensor is configured as a field effect transistor, the semiconductor layer will typically contain a source and drain which are differently doped than the bulk of the layer (e.g. the source and drain are n-type while the rest of the layer is p-type). In an embodiment the semiconducting layer is silicon. In an embodiment, the silicon may be n doped or p doped. In an embodiment, the silicon is n-doped with a resistivity of 1-100 ohm-cm. Alternately, the semiconducting material may be selected from Si, Ge, GaP, InAs, InP, SiGe, GaAs or other III/V compounds. Further details of the construction of MIS sensors are known to those skilled in the art. Hughes et al. (Hughes, R. C., R. Bastasz, and W. P. Ellis, Hydrogen Sensing in Vacuum Systems with Catalytic Field Plate Mnos Capacitors. Applied Surface Science, 1997. 115(1): p. 74-79), Lundstrom (Lundstrom, I., Why Bother About Gas-Sensitive Field-Effect Devices? Sens. Actuators A, 1996. 56: p. 75-82; Lundstrom, I., Hydrogen Sensitive Mos-Structures: 1. Principles and Applications. Sens. Actuators, 1981. 1: p. 403-426), and Lundstrom and Soderberg (Lundstrom, I. and D. Soderberg, Hydrogen Sensitive Mos-Structures: 2. Characterization. Sens. Actuators, 1981. 2: p. 105-138) hereby incorporated by reference, provide examples of MIS sensor configurations.

Optionally, the sensor may include a selective layer in contact with the metal layer, with the selective layer being chosen to limit diffusion of molecules larger than acetylene through the layer. This selective layer may be of a nonporous polymeric material. In an embodiment, the layer of polymeric material is not a polyimide layer. The selective material may also be of a porous inorganic material, such as a molecular sieve material of appropriate pore size.

In different embodiments, a sensor is “sensitive to” acetylene when a change in acetylene concentration of at least 10%, 20% or 25% produces a change in electrical signal above a detection threshold for the sensor. In an embodiment, the detection threshold for a capacitance sensor may be 1 mV. In an embodiment, the acetylene and hydrogen sensitive capacitance MIS sensor produces a shift in voltage of at least 1 mV for a 100 ppm change in acetylene concentration (at constant hydrogen concentration and for an acetylene concentration less than 1000 ppm). In an embodiment, the voltage shift is determined from the “steady state” voltage signal for the sensor in the gas mixture. In an embodiment, the steady state voltage signal may be obtained within 30 seconds, 1 minute or 1.5 minutes after a change in composition of the gas mixture. This steady state voltage signal may also be defined with respect to the reference sensor, with steady state being obtained within 30 seconds, 1 minute or 1.5 minutes. The sensor response to a change in hydrogen concentration alone may be even faster. The change in current for a change in acetylene concentration for other types of MIS sensors may be directly correlated with the voltage response obtained for capacitance MIS sensors.

The calibration signal indicates the sensor's response to a hydrogen-containing gas mixture that is free of acetylene. The calibration signal may be obtained from a hydrogen selective calibration sensor. For a hydrogen selective sensor, changes in sensor output due to changes in hydrogen concentration are larger than changes in sensor output due to equivalent concentration changes of other gases. The extent to which a sensor preferentially responds to hydrogen in a gas mixture can be determined by the extent to which the sensor voltage shift is due to hydrogen. In the ideal limit, a hydrogen selective sensor responds only to hydrogen and is not affected by other gases. The calibration signal may also be obtained from a sensor which is not sensitive to acetylene, but is sensitive to other gases which may affect the response of the MIS sensor used to detect acetylene. A sensor may be “sensitive to” hydrogen when a change in hydrogen concentration of at least 10%, 20% or 25% produces a change in electrical signal above a detection threshold for the sensor. In an embodiment, the calibration or reference capacitance sensor produces a shift in voltage of at least 100 mV for a 100 ppm change in hydrogen concentration (in the absence of acetylene, hydrogen concentration range 0 to 100 ppm). At higher hydrogen concentrations, the voltage shift may be smaller (e.g. at least 10 mV at a concentration of about 1000 ppm). The acetylene sensitive sensor may have the same hydrogen sensitivity as or similar hydrogen sensitivity to the calibration sensor. In different embodiments, a sensor is “not sensitive to” acetylene when a change in acetylene concentration of 1000 ppm or less, 100 ppm or less, 10 ppm or less, or 1 ppm or less is below the detection threshold for the sensor. In an embodiment, the calibration or reference capacitance sensor produces a shift in voltage less than 1 mV for a 100 ppm change in in acetylene concentration (at constant hydrogen concentration).

In an embodiment, the electrical signals from the acetylene sensitive sensor and the reference signal can be directly compared. The signals being compared may be the “steady state” signals for each sensor for a given gas mixture or liquid solution composition. In another embodiment, the electrical signals from the acetylene sensitive sensor and/or the reference signal can be processed to account for any differences in the predetermined relationship between the electrical signal from the sensor and the hydrogen concentration in the environment.

In an embodiment, the calibration sensor may be a metal-insulator-semiconductor sensor having a metal layer which is not sensitive to acetylene. Suitable metals for such a calibration sensor include, but are not limited to, palladium, and platinum.

The hydrogen selective calibration sensor may be a metal-insulator-semiconductor sensor having a metal layer which is sensitive to acetylene, but also having a hydrogen selective layer which limits diffusion of acetylene to the metal layer. This selective layer may be of a nonporous polymeric material. In an embodiment, the selective layer is a polyimide layer. Useful polyimides include, but are not limited to polyimide (PI) Pyralin® PI-2555 (a reaction product of benzophenone tetracarboxylic dianhydride 4,4-oxydianiline m-phenylene diamine, BTDA-ODA-MPD; purchased from DuPont HD Microsystems™. Other polyimide materials to impart hydrogen selectivity are discussed in U.S. Pat. No. 7,340,938, hereby incorporated by reference. The selective material may also be of a porous inorganic material, such as a molecular sieve material of appropriate pore size. The sensor may be matched to the environment by considering the gases other than hydrogen which are expected to be present in the environment and which are expected to vary in concentration and selecting the hydrogen selective material to be highly selective for hydrogen over these gases.

The MIS sensor may be exposed to the environment by placing the sensor in a gaseous environment or by placing the sensor in a liquid environment which comprises a mixture of gases dissolved in the liquid. The liquid may be an oil or a solvent. Suitable oils for the practice of the invention include, but are not limited to mineral oil and silicon oil.

In different embodiments, the environment temperatures may be from 20° C. to 400° C., 20° C. to 200° C., 20° C. to 125° C., 20° C. to 100° C., 50° C. to 400° C., 50° C. to 200° C., 50° C. to 125° C. or 50° C. to 100° C. The temperature may be selected to limit the extent of acetylene dissociation.

In an embodiment, the signal processing device is a device capable of comparing the currently generated electric signal from the MIS device to a known calibration signal. Comparison will usually involve microcircuitry of either analog or digital design.

Variation in the signal output between the calibration sensor and acetylene-sensitive sensor can be used to indicate the presence of acetylene in the hydrogen-containing gas mixture or liquid solution. The amount of variation can also quantitatively determine the amount of acetylene, for example by comparison to reference data generated for different acetylene concentrations. Both the calibration and the acetylene-sensitive sensors may be pre-calibrated before installation at a site in mixtures of known composition

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The following definitions are provided to clarify their specific use in the context of the invention.

One skilled in the art readily appreciates that the present invention is well adapted to carry out the objects and obtain the ends and advantages mentioned, as well as those inherent in the present invention. The methods, components, materials and dimensions described herein as currently representative of preferred embodiments are provided as examples and are not intended as limitations on the scope of the invention. Changes therein and other uses which are encompassed within the spirit of the invention will occur to those skilled in the art, are included within the scope of the claims.

Although the description herein contains certain specific information and examples, these should not be construed as limiting the scope of the invention, but as merely providing illustrations of some of the embodiments of the invention. Thus, additional embodiments are within the scope of the invention and within the following claims.

### Example 1

### 1. Introduction

Metal-insulator-semiconductor (MIS) devices are a promising solid-state technology for monitoring a wide range of gases in commercial applications. These sensors consist of a layered metal-oxide-semiconductor structure used to detect changes in gas concentrations by measuring a bias voltage across the device (FIG. 1); shifts in this bias are controlled by the sorption of hydrogen atoms into the device [1]. Hydrogen dissociates on the catalytic metal surface to form H atoms, and these H atoms diffuse through the metal film to the metal-insulator interface, [2] causing a shift in the capacitance-voltage (CV) curve [1]. The voltage shift is required to maintain a constant capacitance at the inflection of the CV curve and is controlled by the sorption of hydrogen atoms into the device. This shift occurs because the layer of interfacial hydrogen created by this process exists in a dipole layer [2].

The MIS sensor response is directly attributable to the steady-state atomic hydrogen concentration in the device. Although mainly used for hydrogen detection, the sensors can be used to detect hydrogen-bearing analyte gas molecules such as acetylene [1]. If the reactant can undergo a surface reaction with hydrogen, as (for example) O₂ and acetylene can, the response decreases because of a reduction in the steady-state interfacial hydrogen concentration [3-6].

Many previous investigations have studied variations in film properties and their effect on sensor performance. For example, compound semiconductors have been investigated for improving device performance at high temperatures [7, 8]. The work described here focuses on variations in the composition of the catalytic metal gate. Palladium, platinum, and iridium films are often used for hydrogen detection because H₂ dissociates readily on these metals [4, 9-13]. Metals such as pure Ag, Cu, and Au do not work well because of their low activity for hydrogen dissociation [14, 15]. Alloying Pd with Cu, Ni, Au, and Ag in some cases increases the sensitivity to hydrogen and resistance to aging, and prevents hydride formation that leads to delamination of the metal film and device failure [1, 15-19]. Another important aspect of bimetallic sensors is the potential to control surface reactivity [20-22]. Hughes et al. [19] studied NO₂, CO, H₂O, propylene oxide, ethylene, and formic acid response in a hydrogen background on Ag/Pd and Pd sensors. They determined that the Ag addition changes the reaction rates on the Pd surface, and this affects the hydrogen response.

Acetylene detection in a hydrogen background is important in many applications including acetylene contamination in ethylene streams for polyethylene production [5, 6, 23] and in fault gases in transformers [2]. There has been substantial work done on the kinetics of acetylene hydrogenation on Pd and Ag/Pd supported metal catalysts. In industry, Ag/Pd catalysts are used for acetylene removal from ethylene streams, i.e., for the selective hydrogenation of acetylene to ethylene [23]. The Ag component enhances the acetylene selectivity to ethylene by decreasing the binding energies of acetylene and ethylene [14, 20, 24], and this leads to increased sensitivity of MIS sensors for acetylene detection. The hydrogenation of acetylene is believed to occur via a Horiuti-Polyanyi mechanism, where hydrogen atoms are sequentially added to a molecule (C₂H₂+H→C₂H₃+H→C₂H₄+H₂→C₂H₅+H→C₂H₆) [14, 25]. The rate limiting step for acetylene hydrogenation to ethane on Pd has been determined to be the first addition of hydrogen to form vinyl [26], and on PdAg to be the fourth addition of hydrogen to form ethane. The rate is also governed by the dissociative adsorption of hydrogen onto the surface and the availability of hydrogen on the surface to carry out the hydrogenation steps [27].

More generally, bimetallics enjoy wide use in many catalytic reactions, but they have not been extensively studied for use in similar chemistry on MIS devices. Previous work has indicated that MIS devices with pure Pd gates are not responsive to acetylene in a hydrogen background [5]. The modification of these Pd-based devices with organic monolayers, however, yielded large acetylene responses. Unfortunately, application of such devices is hampered by the instability of the monolayer coatings even during room temperature exposure to air [5]. By operating MIS sensors at higher temperatures, unsaturated hydrocarbons like acetylene and ethylene can be detected due to their decomposition to carbonaceous species and hydrogen, but these responses are very small in the presence of H₂ [28].

This work explores connections between catalysis by bimetallics and design of solid-state sensors. A variety of bimetallic combinations including Ag/Pd, Au/Pd, Cu/Pd, and Ni/Pd at varying compositions were tested to identify the metal composition that responds best to acetylene. A kinetic model for acetylene hydrogenation on the Ag/Pd surface, which had the largest response, was developed. This kinetic modeling approach provides a useful connection with acetylene hydrogenation catalysis that may allow bimetallic sensors to be designed based in part on previous studies of bimetallic catalysts (or vice versa).

### 2. Methods

### 2.1 Sensor Fabrication

Sensors were prepared from 100 mm diameter, 1 mm thick n-type (P, 10 ohm-cm) Si wafers with a 50 nm film of SiO₂ deposited as a thermal oxide and 40 nm of Al sputtered onto the backside to form an ohmic contact (University Wafer). The Pd metal or Pd bimetallic gate was evaporated onto the surface using a dual electron beam evaporator (Angstrom Sciences, EBES-67369) at Sandia National Laboratories in Livermore, Calif. The evaporator was housed in a vacuum chamber with a base pressure of 10⁻⁶ torr. Pd and Au, Ag, Cu, or Ni pellets (>99.9%, Kurt J. Lesker) were melted in alumina crucibles (Kurt J. Lesker) and evaporated onto the oxide side of the wafers which were suspended above the crucibles. Quartz crystal microbalances (Inficon XTC/2) were positioned above the Pd and solute metal (Au, Ag, Cu, or Ni) crucibles to monitor the relative rate of evaporation and control solute metal concentration. Another microbalance was positioned next to the wafer substrate to monitor total deposition rate and film thickness. Film compositions included 5%, 15%, and 40% solute metal by weight for Ag/Pd and Cu/Pd sensors, 15% and 40% solute metal by weight for Au/Pd, and 5%, 40%, and 60% solute metal by weight for Ni/Pd sensors. Total metal film thickness in every case was 50 nm. After metal deposition, the wafers were diced into ⅛″×⅛″ squares (American Precision Dicing) and an electrical contact was applied to the gate metal using silver epoxy (M.E. Taylor Engineering, inc).

### 2.2 Sensor Flow Cell Testing

The sensors were inserted into a gas flow cell, and kept in place by a sample holder. Heating tape was wrapped around the system and a temperature controller (Omega Engineering) was used to control the sensor temperature, which was measured by a thermocouple attached to the sample holder. The voltage required to maintain the capacitance at the inflection point of the capacitive-voltage (CV) curve was recorded to measure the changes in the CV curve of the sensor. The flow cell geometry and method of response measurement has been described in detail previously [2].

Bimetallic MIS sensor response to acetylene was examined by the sequential introduction of H₂ and acetylene into the flow cell. After equilibrating the device in 500 ppm of hydrogen in nitrogen at a flow rate of 380 sccm, 100 ppm of acetylene was added to the system. These gas compositions roughly correspond to those of interest for the detection of acetylene in electrical transformers [2, 5]. Acetylene was removed once reaching steady state. At least two repeated doses of 100 ppm acetylene at 323, 348, and 398 K over the sensor device were performed. For each case, evaluation of the response consisted of taking the difference between the steady state bias before and after acetylene exposure. This final step is important to distinguish a real response from a well known drift problem where the CV curve can shift up to 10 mV/h [29]. These experiments used ultra high purity gases obtained from Airgas. Additional tests at 40 and 400 ppm acetylene and at 100 ppm ethylene were performed on the PdAg sensors in a 500 ppm hydrogen background.

### 2.2 Kinetic Modeling

A kinetic model for acetylene hydrogenation on Pd₅₀Ag₅₀ and Pd was developed, and simulated using Chemkin [30]. We note here, and further discuss below, that the Pd₅₀Ag₅₀ composition differs from the bulk compositions of the films tested experimentally. Silver segregates to the surface of Ag/Pd, for example to over 90% when the bulk composition is 33% Ag [31, 32]. The addition of H₂ may reduce this surface segregation, [31] so the actual Ag percentage at the sensor surface under reaction conditions is unknown. Thus Pd₅₀Ag₅₀, though not an exact surface composition studied experimentally, was used to provide insight into the reaction mechanism by probing how the addition of Ag affects the kinetics of individual reactions. For the model systems, compositions are reported in mole percent, though the similar molecular weights of Pd and Ag cause this to be nearly equivalent to mass percentage. The experimental system was modeled as a perfectly-stirred reactor (PSR) model. To test this approximation, experiments were conducted in which the total feed rate was varied at 323, 348, and 398 K. The measured response did not change with the increased feed rate indicating that a great excess of the reactants exists in the chamber (differential conversion) relative to the relatively low surface area of the sensors; thus, the gas composition can be considered uniform and the PSR model is a suitable approximation. The PSR code solves a system of nonlinear algebraic relations that balance mass and energy using a hybrid Newton/time integration method [30]. Most of the results reported below are for steady-state operation, i.e. when reaction rates have become invariant with time, but in some cases time dependent behavior is reported.

Selective hydrogenation of acetylene was modeled as a sequence of reaction steps using kinetic expressions taken from the literature as summarized in Table 1 [3, 20, 27, 33-35] which shows activation energies (kcal/mol) for elementary reactions over Pd and PdAg surfaces. A Pd or PdAg surface site is represented by (s). Chemkin was used to numerically solve the system of coupled material balances shown in Table 1 in a manner described previously [3]. Briefly, Chemkin expresses the net rate of formation of each reactant, product, and intermediate species in terms of the rate of all processes that produce the intermediate subtracted by the rate of all processes that consume the intermediate. In the case of vapor-phase reactants and products, convective flow terms are also incorporated into the balance. Thus, for example, the rate of accumulation of the surface intermediate CCH(s) can be expressed as:

$$\frac{d [ CCH ]}{d t} = {k}_{11} [ {C}_{2} {H}_{2} ( s ) ] [ S ] - {k}_{- 11} [ CCH ( s ) ] [ H ( s ) ] - {k}_{17} [ CCH ( s ) ] [ H ( s ) ] + {k}_{- 17} [ {CCH}_{2} ( s ) ] [ S ] - {k}_{18} [ CCH ( s ) ] [ S ] + {k}_{- 18} [ C ( s ) ] [ CH ( s ) ] . \qquad ( 1 )$$

Miller et al., 2011, Sensors and Actuators B, 156, 924-931, hereby incorporated by reference, shows this equation with the k₁₈ terms omitted.

In Eq. 1, the individual rate constants k are subscripted by the reaction number in Table 1, with positive (negative) subscripts corresponding to forward (reverse) reactions. The rate constants for each reaction are of standard Arrhenius form. Except where noted otherwise, all frequency factors in these Arrhenius expressions assume negligible activation entropy [27], and the activation energy for each reverse reaction is simply equal to that of the forward activation energy minus the reaction energy. The quantity [S] refers to the surface concentration of vacant sites. Each of the species concentrations in Eq. 1 will have a similar balance associated with that species, resulting in a system of coupled differential equations that are solved numerically after specifying initial conditions. In general, the surface was initially assumed to consist purely of vacant surface sites. A number of secondary C₂ surface intermediates such as ethylidyne and vinylidene are known to form on Pd and are therefore included in the model. The complete mechanism and activation energies for acetylene and ethylene hydrogenation on Pd and Pd₅₀Ag₅₀ were taken from Mei et al. [27]. The pre-exponential factors for hydrogen, acetylene, and ethylene adsorption were calculated from their sticking coefficients using Eq 2 [36].

$${k}_{ads} = A * {e}^{- Ea / RT} = \frac{s}{{σ}^{2}} \sqrt{\frac{R T}{2 π {M}_{k}}} \qquad ( 2 )$$

where k_{ads}=the adsorption rate constant, A=pre-exponential (frequency) factor, Ea=activation energy, R=rate constant, T=temperature, s=sticking coefficient, σ=site density, and Mₖ is molecular weight. The activation energy for adsorption was assumed zero, thus the k_{ads} equals the pre-exponential factor. Sticking coefficients of 1, 0.83, and 0.75 were used for hydrogen, acetylene, and ethylene, respectively, for Pd and PdAg [6, 33].

Kinetic models were run at variable acetylene concentrations in 500 ppm hydrogen with the balance being nitrogen at 323-398K on Pd and Pd₅₀Ag₅₀. To aid in comparing the experimental response to model results, interfacial hydrogen concentration and hydrogen consumption rates were calculated. The voltage response, ΔV, from the sensor is assumed to be directly proportional to the concentration of H atoms at the interface, θ_{H(i)}, (Eq 3) where c is some constant [37]:

ΔV=cθ_{H(I)} (3).

Previous groups described sensor response through interfacial hydrogen calculations [3, 38-40]. Fogelberg et al. [38] postulated that the relation shown in equation 4 governs the equilibrium between surface-bound and interfacial hydrogen:

ξθ_{H(s)}(1−θ_{H(i)})=ηθ_{H(i)}(1−θ_{H(s)}) (4),

where ξ and η are rate constants of the Arrhenius form, θ_{H(s)} is the fractional coverage of atomic hydrogen on the surface, and θ_{H(i)} is the fractional coverage of atomic hydrogen at the interface. This relationship assumes rapid diffusion of hydrogen through bulk Pd [41], and that only hydrogen is on the surface. On a surface containing other species, a site balance must be constructed to account for the change in vacant Pd sites. Medlin et al. [3, 39] incorporated this correction for additional species on the surface to create an equation that is consistent with site conservation principles of a single-site elementary model. respectively, for Pd and PdAg [6, 33].

A possible problem with these models is they do not consist of a sequence of elementary steps, and are therefore potentially not thermodynamically consistent. In particular, hydrogen dissociative adsorption is assumed to be a non-elementary process that is first order in the concentration of vacant sites, while hydrogen desorption was assumed to be elementary, i.e. second-order in hydrogen-bearing surface sites. For the current study, the adsorption and desorption of hydrogen were both described as second order equations (Eq. 5) to provide a thermodynamically consistent solution; at equilibrium, the rates of adsorption and desorption should be equal, i.e.

k_{ads}P_{H}_{₂}(s)²=k_{des}(H(s)) (5)

To test the thermodynamic consistency of the model in Chemkin, the surface site density was varied to ensure that the equilibrated sensor response, H(i), was independent of the concentration of surface sites and depended only on the gas-phase composition. The results were then applied to the interfacial and surface-bound hydrogen equilibrium relationship (Eq. 6).

ξθ_{H(s)}θ_{Pd(i)}=ηθ_{H(i)}θ_{Pd(s)} (6)

where θ_{Pd(s)} is the fractional coverage of palladium sites at the surface, and θ_{Pd(i)} is the fractional coverage of palladium sites at the interface. This relationship was used to calculate the interfacial hydrogen concentration after solving for the surface hydrogen and palladium concentrations calculated from Chemkin. The adsorption, desorption, and diffusion kinetic expressions for hydrogen between the surface and interface were taken from the work of Johansson et al [6]. Kinetic parameters for interfacial hydrogen accumulation were assumed to be invariant with film composition. The η term is dependent on interfacial hydrogen concentration as shown in equations 7-8.

Eαₒᵤₜ=16.14−18.15*θ_{H(i)} (7)

η=A*ê(−Eαₒᵤₜ/RT) (8)

Because of the significant uncertainties associated with modeling hydrogen accumulation at a buried interface, the rate of H₂ consumption was also used as a measure of sensor response, in line with previous analysis which indicates that decreases in sensor response caused by addition of a reactive analyte should roughly scale with the rate of hydrogen consumption [5]. Hydrogen consumption was calculated by equation 9.

H₂ Consumption=(X_{H2in}−X_{H2out})*m/MWₘᵢₓ (9)

where X_{H2in} is the mole fraction of hydrogen entering and X_{H2out} is the mole fraction of hydrogen leaving the system, m is the total mass flow rate, and MWₘᵢₓ is the total molecular weight of the mixture.

### 3. Results

### 3.1 Experimental Measurements of Bimetallic MIS Response

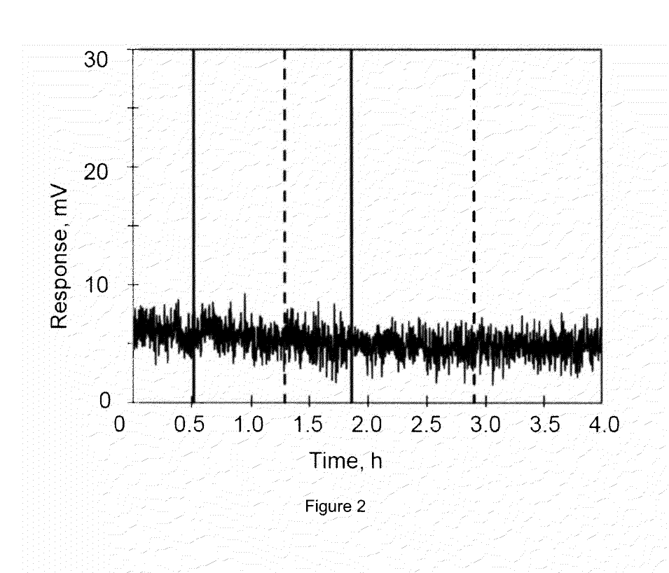

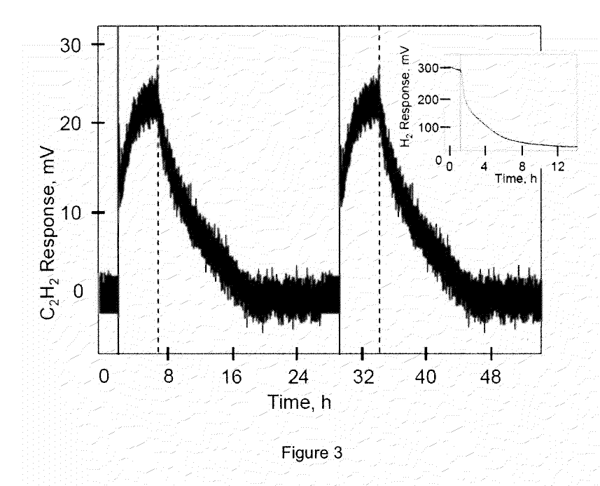

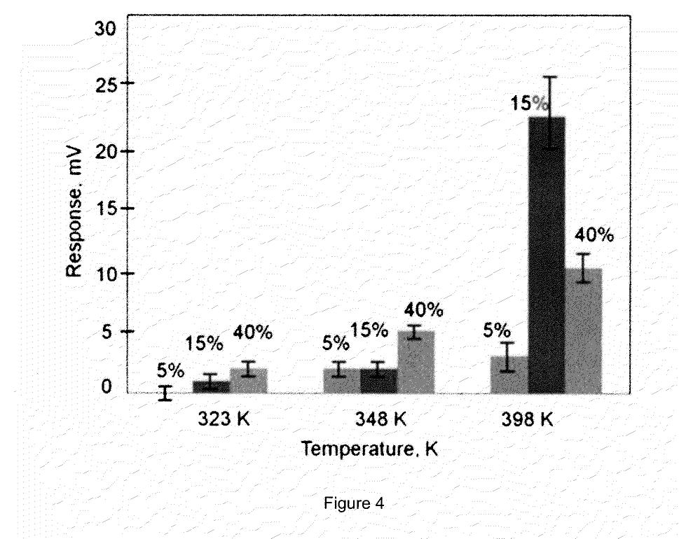

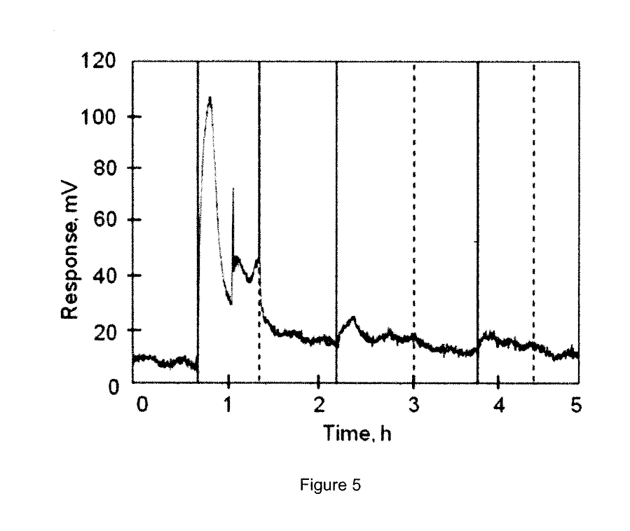

Multiple MIS sensors were tested including: Pd, Ag/Pd (5, 15, and 40% Ag), Au/Pd (15 and 40% Au), Cu/Pd (5, 15, and 40% Cu), and Ni/Pd (5, 40, and 60% Ni). A large sensor response (measured as a decrease in bias voltage) appeared on all the sensors almost immediately after addition of H₂. An acetylene stream was switched into the flow cell after the H₂ response equilibrated. An increase in signal to a more positive bias voltage corresponds to acetylene consuming hydrogen through a surface hydrogenation reaction that lowers the steady state concentration of interfacial hydrogen. The absence of response suggests that acetylene hydrogenation does not happen at a sufficiently rapid rate to alter hydrogen adsorption into sensing sites. A decrease in bias voltage corresponds to acetylene adsorption accelerating H₂ adsorption or decomposing to produce hydrogen atoms [5]. In all cases where a significant response was observed on the bimetallic sensors, the bias increased (i.e., response decreased), indicating that acetylene was detected through consumption via a hydrogenation reaction. Table 2 summarizes the responses obtained for all the bimetallic sensors tested at 100 ppm acetylene and at 323, 348, and 398 K on Ag/Pd, Au/Pd, Cu/Pd, and Ni/Pd sensors. Experiments were performed a minimum of three times with a standard deviation below ±3 mV for all numbers reported below. (Sensor response in mV.) Acetylene did not produce a significant response on Pd (FIG. 2), and produced the best response on the 15% Ag/Pd sensor at 398 K with a bias shift of approximately 22 mV (FIG. 3). This result was repeated on three separate devices produced from the same wafer. Temperature and metal composition played a major but complex role in response, as discussed in detail below. FIG. 4 shows response for 5, 15, and 40% Ag/Pd sensors at 323 K, 348 K, and 398 K. The results at 348 K on the Cu/Pd sensors appeared promising, but when the temperature was increased to 398 K, the response was not repeatable and never reached steady state. One example is on the 15% Cu/Pd sensor. An initial response of 34 mV was obtained, but after adding and removing acetylene twice more over 3 hours the response decreased to 3 mV as shown in FIG. 5. This result could be consistent with an irreversible structural change at the surface of the sensor, but further study is needed to confirm this conjecture. The Ag/Pd MIS sensors were also tested at varying acetylene concentration. The three Ag/Pd bimetallic compositions were tested in a 500 ppm hydrogen background at 40, 100, and 400 ppm acetylene (Table 3) at 323, 348, and 398 K. Table 3 gives a summary of Ag/Pd sensor response to 40, 100, and 400 ppm acetylene in 500 ppm hydrogen. Experiments were performed a minimum of three times with a standard deviation below ±3 mV for all numbers reported below. (Sensor response in mV.) Higher acetylene concentration did not lead to higher responses in all cases. This could be due to increased accumulation of carbonaceous species that foul the surface, as discussed below. The Pd and PdAg sensors showed no detectable response to 100 ppm ethylene in a 500 ppm hydrogen background at 323, 348, and 398 K. This is consistent with previous investigations using both unmodified and organic monolayer-modified Pd-MIS devices; while the devices modified with organic monolayers responded strongly to acetylene in the presence of hydrogen, neither type of device responded to ethylene. [5]

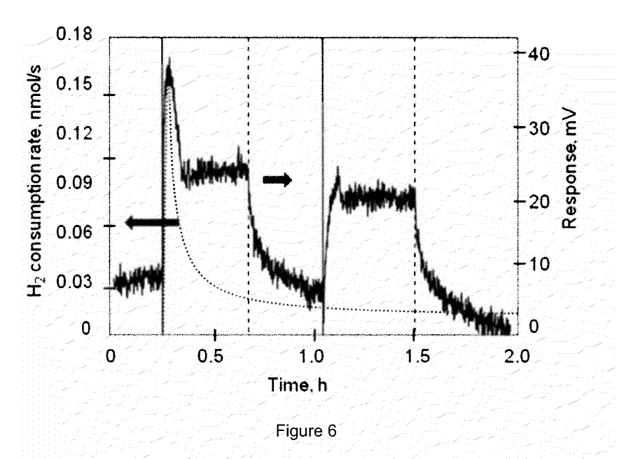

After achieving a steady state response, sensors were observed to exhibit stable operation with time over a period of several days, but their longer term stability is not known. It is worth noting, however, that PdAg catalysts have been found to be more stable during acetylene hydrogenation because of reduced propensity for carbon fouling, suggesting that the lifetime of the bimetallic surfaces may be greater than the single-metal surfaces [27,41]. One interesting observation was that during the first acetylene exposure on the Ag/Pd sensors, the response went through an apparent “overshoot” in which the voltage increased rapidly, but then decreased to a lower-steady state value as shown in FIG. 6. This overshoot was not seen for subsequent doses performed immediately after the first dose. However, when the sensor remained overnight in a hydrogen stream, the overshoot in response was observed with the initial acetylene addition the next day. The observed overshoot increased with temperature and Ag content. The kinetic modeling findings described below provide insight into this phenomenon.

### 3.2 Kinetic Modeling Studies

A kinetic model was developed for acetylene hydrogenation surface reactions on PdAg surfaces to determine how addition of Ag may result in the experimentally observed higher acetylene sensitivity. Compositions of Pd₅₀Ag₅₀ and Pd were selected because of the availability of kinetic parameters from previous work at these compositions. Although the Pd₅₀Ag₅₀ composition likely differs from those present at the surface of the sensors tested experimentally, it does allow for an assessment of how adding Ag results in changes in sensor response to acetylene.

The modeling results generally showed similar directional trends to the experimental measurements, but with some significant quantitative differences. As described in Section 2.2 above, two methods of quantifying the sensor response were used. The first method involves a direct calculation of the interfacial hydrogen coverage, which should scale linearly with response. Thus, decreases in the interfacial hydrogen concentration after the introduction of acetylene are correlated with increases in bias voltage (decreased response) due to the consumption of hydrogen by reaction with acetylene. However, calculating the interfacial hydrogen concentration also requires a number of assumptions related to the interfacial hydrogen dynamics (see Section 2.2). The second method assumes that the rate of hydrogen consumption is closely related to device response, and thus uses the hydrogen consumption rate as a stand-in for response [5].

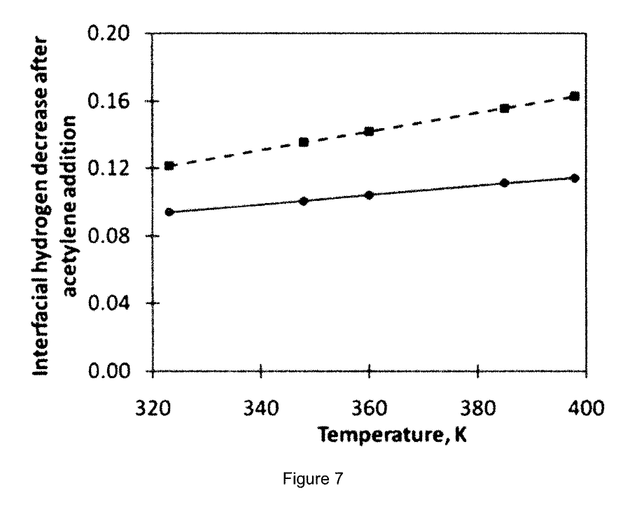

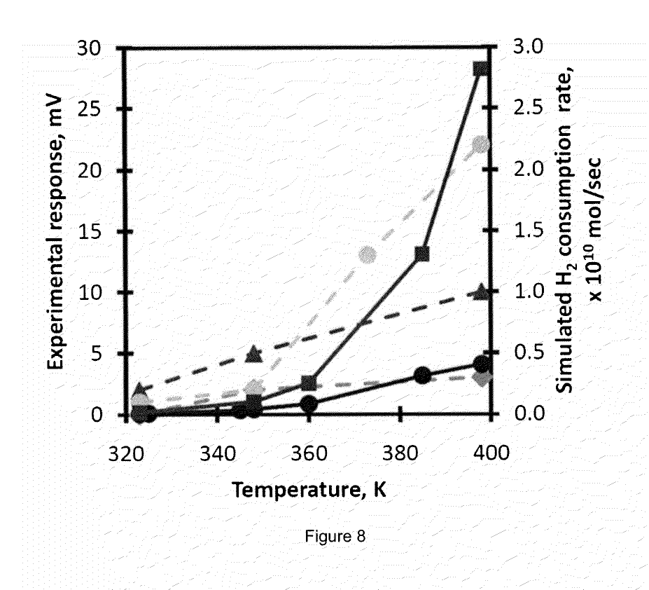

To estimate acetylene-induced response, the steady-state interfacial hydrogen concentration was calculated for two cases: for 500 ppm H₂ feed with no acetylene and for 100 ppm acetylene in 500 ppm hydrogen feed with the balance being nitrogen. The greater the difference between θ_{H(i)} with pure H₂ feed and 100 ppm C₂H₂/H₂ feed, the greater the magnitude of the sensor response. As shown in FIG. 7 the θ_{H(i)} difference was greater on the Pd₅₀Ag₅₀ surface than on the Pd surface, and the θ_{H(i)} differences increased with temperature for both surfaces. This corresponds to both the larger acetylene-induced change in response on the Ag/Pd surfaces and the larger responses at higher temperatures seen experimentally. The rate of hydrogen consumption also increased with temperature because of the more rapid surface consumption of acetylene (see Discussion), and was greater on the PdAg surfaces compared to Pd. FIG. 8 shows hydrogen consumption plotted with sensor response to show that both dramatically increase with temperature at 100 ppm acetylene, and the hydrogen consumption of Pd is much lower corresponding to lack of response seen on the Pd sensor.

The general qualitative agreement between experimental and modeling results described above indicates that the model may be useful for interrogating the surface chemistry, but it should be noted that agreement is not quantitative and varies between the methods of modeling response. For example, the interfacial hydrogen model predicts a much smaller response enhancement for PdAg compared to Pd sensors than is actually observed; the hydrogen consumption rate seems to better demonstrate the strong increase in response from addition of Ag. Additionally, the interfacial hydrogen method predicts a nearly linear relationship between hydrogen response and temperature, whereas the rate of hydrogen consumption appears to depend more strongly on temperature. The experimental results are mixed, with the response of the 40% Ag sensor appearing to depend on temperature more weakly than that of the 15% Ag sensor. However, quantitative agreement between the model and experiment is not necessarily expected given the differences in experimental versus model Ag compositions. The model does provide a convenient way to interrogate likely mechanisms for observed temperature and composition effects.

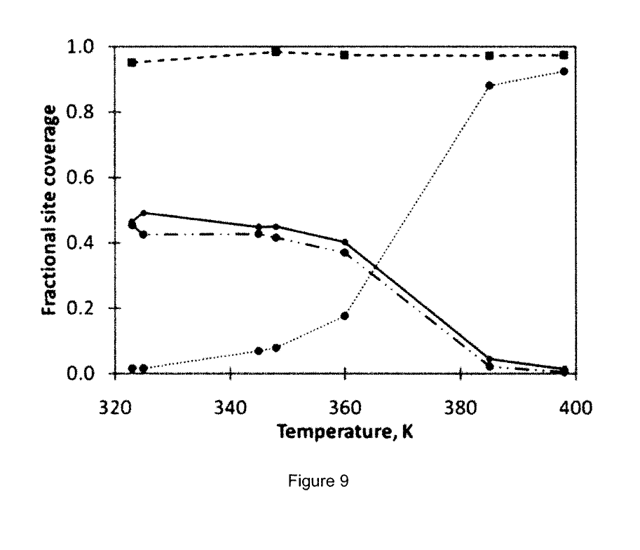

Temperature and Ag content play a key role in the production of carbonaceous surface species, most notably CCH(s) for PdAg and CH(s) and C(s) for the Pd surface. The high coverages of carbonaceous species observed in the simulations are consistent with the known importance of such species in the industrial acetylene hydrogenation process over Pd and PdAg surfaces [27, 42]. FIG. 9 shows carbon species accumulation versus temperature for both surfaces. The coverage of acetylene on Pd, which is significant at low temperatures due to the relatively strong binding of unreacted acetylene, is also shown. On Pd₅₀Ag₅₀, CCH(s) covered 95-97% of the surface sites at all temperatures, suggesting limited decomposition of acetylene on the surface with the highest Ag content. On the pure Pd surface, significant accumulation of single-carbon species is apparent even at low temperatures, with a transition from CH(s) to C(s) as temperature is increased. Overall, the model results present a picture where the presence of Ag and/or decreased temperature is associated with a decreased propensity for decomposition to single-carbon species.

Sensitivity analysis was used to determine the reactions that had the largest effect on the coverages of various surface species on the three different metal surfaces. Here we focus on the sensitivity for surface hydrogen, H(s), since this has a substantial effect on the sensor response. Interestingly, while the H(s) concentration on pure Pd was most sensitive to changes in the hydrogen adsorption/desorption kinetics, on the bimetallic surface sensitivity was highest to acetylene adsorption. In other words, the shift in acetylene adsorption energy on the bimetallic surfaces is sufficient to result in a shift in the degree of rate control of the various steps, consistent with a significant change in acetylene reactivity.

### 4. Discussion

Changes in the prevalence of various intermediates and products are the result of varying activation energies on the different surfaces. The two main reaction paths for acetylene are production of CHCH₂ (s) (Eq. 10), which then forms C₂H₄ (s) (Eq. 11), or decomposition to CCH (12). A surface site is represented by (s).

C₂H₂(s)+H(s) [symbol] CHCH₂(s)+(s) (10)

CHCH₂(s)+H(s) [symbol] C₂H₄(s)+(s) (11)

C₂H₂(s)+(s) [symbol] CCH(s)+H(s) (12)

Reaction (11) is much more rapid on the PdAg surface, leading to faster consumption of acetylene. Operation of sensors at higher temperatures results in more rapid consumption of acetylene because the activation barriers for reactions (10) and (11) are easier to overcome. On Pd₅₀Ag₅₀, CCH(s) accumulates because the lowest-barrier path to remove CCH(s) from the surface requires hydrogen (13), which is not abundant on the surface. CCH(s) can also be eliminated via C-C dissociation in a higher activation energy process. This reaction occurs to a significant extent on Pd but is not observed to play a major role on the Pd₅₀Ag₅₀ surface. It is interesting to note that the overshoot in response observed in the experiments may be due to the accumulation of hydrocarbon intermediates on the surface. That is, when acetylene is first introduced the surface is largely free of carbonaceous species, such that there are a large number of surface sites available for the reaction of acetylene with hydrogen. As the reaction proceeds, however, carbonaceous species accumulate on the surface and slow the reaction of acetylene with hydrogen. FIG. 6 shows the relationship of experimentally observed overshoot to the model prediction of H₂ consumption, and the two curves show a remarkable qualitative similarity. Furthermore, the removal of carbonaceous species from the surface took 20-25 hours when the model conditions were changed such that acetylene was removed from the feed stream, consistent with the experimental observation that overshoot did not recur in repeated experiments unless the sensor was left in flowing hydrogen overnight. More generally, relatively slow changes in the coverage of carbonaceous species may account for the long times required to achieve steady-state, as shown in FIG. 3. Finally, it is interesting to note that even on a surface that does not exhibit a significant acetylene response, i.e. the pure Pd surface, model simulations show that the introduction of acetylene causes the surface to become largely covered with carbonaceous species. However, in the case of pure Pd this does not result in rapid consumption of hydrogen, and thus does not have a strong effect on sensor response.

Although the model studies show why the addition of some Ag leads to an enhanced hydrogen response, these model results are not sufficient to explain why the 15% Ag/Pd sensors were found in experimental studies to exhibit the largest response. Nevertheless, it is well known from studies of acetylene hydrogenation catalysis that as the Ag content becomes very high, the acetylene hydrogenation rate decreases due to weak interactions of reactants with the surface [43]. Thus, one would expect an optimal composition beyond which the rate of acetylene hydrogenation would begin to decrease. Note that increases in acetylene feed concentrations to 400 ppm increased the coverage of carbonaceous species on both surfaces. The greater accumulation of carbonaceous species at higher acetylene concentrations may explain the apparent decrease in acetylene response observed for the 15% Ag sensor at higher acetylene concentrations. Experiments with other Ag levels over a range of experimental conditions are needed to further explore this hypothesis.

An advantage of using PdAg is to control the selectivity of acetylene hydrogenation to ethylene. The model confirms the enhanced selectivity on Pd₅₀Ag₅₀ that was calculated to be nearly 100% at all temperatures, compared to on Pd, where the selectivity was calculated to be 34%, 36%, and 82% for 323, 348, and 398 K, respectively. When sufficient hydrogen is present, acetylene reacts to form CHCH₂, (Eq. 10) that subsequently forms C₂H₄(s), which is the desired product, (Eq. 11) and CHCH₃(Eq. 13).

CHCH₂(s)+H(s) [symbol] CHCH₃(s)+Pd(s) (13)

To aid in preventing the conversion of ethylene to ethane, the desorption energy for ethylene and hydrogen is decreased, and the activation energy for ethane production from C₂H₅(s) is increased on PdAg.

It is important to emphasize that comparisons between experiments and the model results described here are approximate and merely describe general trends. Because the surface Ag composition is not known under experimental conditions, a direct mapping of experimental to modeling results is not possible. Nevertheless, the results provide a strong indication that the carbonaceous species formed on the surface during reactions play a key role in dictating response. This has important consequences both for efforts to detect gases in hydrogen containing streams, and for detection of hydrogen in streams containing some hydrocarbon contaminants. Furthermore, these results suggest an intimate link between well-studied heterogeneous catalytic reactions and response trends on MIS devices. Such a link can potentially be exploited in future studies aimed at identifying improved MIS sensors for various applications, or for perhaps using MIS architectures to screen new catalytic materials.

### 5. Conclusions

A variety of bimetallic sensors were screened for acetylene response in a hydrogen containing stream, and Ag/Pd sensors were identified as being potentially promising for acetylene MIS sensor response. Acetylene response is influenced both by Ag composition and temperature, and the highest response was obtained on 15% Ag/Pd at 398 K. Kinetic modeling provided insights into how temperature, feed concentration, and percent Ag in the bimetallic alloy affected response. Carbonaceous species formed on the surface, mainly CH(s) and C(s) on Pd but CCH(s) on Pd₅₀Ag₅₀. The accumulation of carbon species may be responsible for dynamic trends in response, and influenced the final response. Response increased with carbon species fouling until a critical concentration of carbon species, where response decreased due to a lower hydrogen consumption rate. Miller et al., 2011, Sensors and Actuators B, 156, 924-931, is hereby incorporated by reference for its discussion of these experimental and modeling studies.

TABLE 1

| | | Sticking | | |
|---|---|---|---|---|
| | | proba- | | |
| | | bility | Pd | |
| | | [3, 18, | [25, | Pd₅₀Ag₅₀ |
| No. | Elementary Reaction | 30] | 32] | [18, 25] |
| 1 | H₂ + 2(s) → 2H(s) | 1 | a | A |
| 2 | 2H(s) → H₂ + 2(s) | | 19.8 | 18.2 |
| 3 | C₂H₂(g) + 2(s) → C₂H₂(s) | 0.83 | | |
| 4 | C₂H₂(s) + H(s) [symbol] CHCH₂(s) + (s) | | 15.8 | 15.8 |
| 5 | C₂H₂(s) [symbol] C₂H₂(g) + 2(s) | | 40.9 | 27.0 |
| 6 | CHCH₂(s) + H(s) [symbol] C₂H₄(s) + (s) | | 17.7 | 2.4 |
| 7 | C₂H₄(g) + 2(s) → C₂H₄(s) | 0.75 | | |
| 8 | C₂H₄(s) + H(s) [symbol] C₂H₅(s) + (s) | | 17.2 | 14.6 |
| 9 | C₂H₄(s) → C₂H₄(g) + 2(s) | | 19.6 | 16.8 |
| 10 | C₂H₅(s) + H(s) → C₂H₆(g) + 3(s) | | 17.0 | 18.6 |
| 11 | C₂H₂(s) + (s) [symbol] CCH(s) + H(s) | | 43.3 | 50.7 |
| 12 | CHCH₂(s) + (s) [symbol] CCH₂(s) + H(s) | | 30.4 | 35.1 |
| 13 | CHCH₂(s) + H(s) [symbol] CHCH₃(s) + (s) | | 20.3 | 17.4 |
| 14 | CHCH₂(s) [symbol] CH₂(s) + CH(s) | | 52.6 | 43.3 |
| 15 | CCH₂(s) + H(s) [symbol] CCH₃(s) + (s) | | 9.3 | 10.5 |
| 16 | CCH₃(s) + H(s) [symbol] CHCH₃(s) + (s) | | 28.7 | 24.4 |
| 17 | CCH(s) + H(s) [symbol] CCH₂(s) + (s) | | 22.2 | 10.0 |
| 18 | CCH(s) + (s) [symbol] C(s) + CH(s) | | 35.4 | 41.3 |
| 19 | CCH₂(s) + (s) [symbol] C(s) + CH₂(s) | | 37.8 | 37.0 |
| 20 | CCH₃(s) + (s) [symbol] C(s) + CH₃(s) | | 29.6 | 31.8 |
| 21 | CHCH₃(s) + (s) [symbol] CH(s) + CH₃ + (s) | | 16.0 | 23.4 |
| 22 | CH(s) + (s) [symbol] C(s) + H(s) | | 28.9 | 29.9 |
| 23 | CH(s) + H(s) [symbol] CH₂(s) + (s) | | 25.1 | 17.2 |
| 24 | CH₂(s) + H(s) [symbol] CH₃(s) + (s) | | 14.8 | 12.7 |
| 25 | C₂H₅(s) + (s) [symbol] CHCH₃(s) + H(s) | | 20.8 | 20.1 |

TABLE 2

| Metal Composition | 323 K | 348 K | 398 K |
|---|---|---|---|
| Pd | 0 | 0 | 0 |
| 5% Ag/Pd | 0 | 2 | 3 |
| 15% Ag/Pd | 1 | 2 | 22 |
| 40% Ag/Pd | 2 | 5 | 10 |
| 15% Au/Pd | 4 | 6 | 0 |
| 40% Au/Pd | 0 | 5 | 0 |
| 5% Cu/Pd | 5 | N/A | −5* |
| 15% Cu/Pd | N/A | 5 | 3* |
| 40% Cu/Pd | N/A | 6 | 3* |
| 5% Ni/Pd | N/A | 3 | N/A |
| 40% Ni/Pd | 2 | 0 | N/A |
| 60% Ni/Pd | 0 | N/A | N/A |

*Unstable

TABLE 3

| % Ag/Pd | Temp, K | 40 | 100 | 400 |
|---|---|---|---|---|
| 5% | 323 | 0 | 0 | 2 |
| | 348 | 1 | 2 | 3 |
| | 398 | 1 | 3 | 7 |
| 15% | 323 | 0 | 1 | 2 |
| | 348 | 0 | 2 | 3 |
| | 398 | 2 | 22 | 15 |
| 40% | 323 | 0 | 2 | 1 |
| | 348 | 1 | 5 | 3 |
| | 398 | 4 | 10 | 9 |

### REFERENCES

[1] J. W. Medlin. 2006. Metal-Insulator-Semiconductor Gas Sensors. Encyclopedia of Sensors. C. A. Grimes, E. C. Dickey, and M. V. Pishko, editor. American Scientific Publishers, Univerisity Park, Pennsylvania. 1.
[2] D. Li, A. H. McDaniel, R. Bastasz, and J. W. Medlin, Sens. Actuators B: Chem. 115 (2006) 86.
[3] J. W. Medlin, A. E. Lutz, R. Bastasz, and A. H. McDaniel, Sens. Actuators B: Chem 96 (2003) 290.
[4] P. Kreisl, A. Helwig, G. Müller, E. Obermeier, and S. Sotier, Sens. Actuators B: Chem 106 (2005) 442.
[5] S. T. Marshall, D. K. Schwartz, and J. W. Medlin, Sens. Actuators B: Chem. 136 (2009) 315.
[6] M. Johansson, I. Lundstrom, and L. G. Ekedahl, J. Appl. Phys. 84 (1998) 44.
[7] C. C. Cheng, Y. Y. Tsai, K. W. Lin, H. I. Chen, C. T. Lu, and W. C. Liu, Sens. Actuators B: Chem. 99 (2004) 425.
[8] K. W. Lin, H. I. Chen, C. C. Cheng, H. M. Chuang, C. T. Lu, and W. C. Liu, Sens. Actuators B: Chem. 94 (2003) 145.
[9] A. Salomonsson, M. Eriksson, and H. Dannetun, J. Appl. Phys. 98 (2005) 10.
[10] A. Spetz, M. Armgarth, and I. Lundstrom, J. Appl. Phys. 64 (1988) 1274.
[11] A. Spetz, U. Helmersson, F. Enquist, M. Armgarth, and I. Lundstrom, Thin Solid Films 177 (1989) 77.
[12] J. Song, W. Lu, J. S. Flynn, and G. R. Brandes, Solid-State Electronics 49 (2005) 1330.
[13] L. G. Petersson, H. M. Dannetun, and I. Lundstrom, Physical Review B 30 (1984) 3055.
[14] N. A. Khan, S. Shaikhutdinov, and H. J. Freund, Catal. Lett. 108 (2006) 159.
[15] Z. Zhao, and M. A. Carpenter, J. Appl. Phys. 97 (2005) 124301.
[16] V. G. Litovchenko, T. I. Gorbanyuk, A. A. Efremov, A. A. Evtukh, and D. Schipanski, Sens. Actuator A-Phys. 74 (1999) 233.
[17] V. G. Litovchenko, T. I. Gorbanyuk, A. A. Efremov, and A. A. Evtukh, Microelectron. Reliab. 40 (2000) 821.
[18] R. C. Thomas, and R. C. Hughes, J. Electrochem. Soc. 144 (1997) 3245.
[19] R. C. Hughes, W. K. Schubert, T. E. Zipperian, J. L. Rodriguez, and T. A. Plut, J. Appl. Phys. 62 (1987) 1074.
[20] F. Studt, F. Abild-Pedersen, T. Bligaard, R. Z. Sorensen, C. H. Christensen, and J. K. Norskov, Sci. 320 (2008) 132.
[21] S. A. Nikolaev, and V. V. Smirnov, Catal. Today 147 (2009) S336.
[22] I. Y. Ahn, J. H. Lee, S. K. Kim, and S. H. Moon, Appl. Catal. A: Gen. 360 (2009) 38.
[23] J. W. Medlin, and M. D. Allendorf, J. Phys. Chem. B 107 (2002) 217.
[24] Q. W. Zhang, J. Li, X. X. Liu, and Q. M. Zhu, Appl. Catal. A-Gen. 197 (2000) 221.
[25] E. W. Hansen, and M. Neurock, J. Catal. 196 (2000) 241.
[26] S. Azad, M. Kaltchev, D. Stacchiola, G. Wu, and W. T. Tysoe, J. Phys. Chem. B 104 (2000) 3107.
[27] D. H. Mei, M. Neurock, and C. M. Smith, J. Catal. 268 (2009) 181.
[28] F. Winquist and I. Lundstrom, Sensors and Actuators 12 (1987) 3.
[29] I. Robins, Sens. Actuators B: Chem 15 (1993) 238.
[30] F. M. R. R. J. Kee, et al., Chemkin Collection, Reaction Design Inc. Release 4.1.1 San Diego, Calif., 2000.
[31] O. M. Løvvik, and S. M. Opalka, Surf. Sci. 602 (2008) 2840.
[32] P. T. Wouda, M. Schmid, B. E. Nieuwenhuys, and P. Varga, Surf. Sci. 417 (1998) 292.
[33] L. Vattuone, Y. Y. Yeo, R. Kose, and D. A. King, Surf. Sci. 447 (2000) 1.
[34] P. A. Sheth, M. Neurock, and C. M. Smith, J. Phys. Chem. B 109 (2005) 12449.
[35] D. Mei, P. A. Sheth, M. Neurock, and C. M. Smith, J. Catal. 242 (2006) 1.
[36] O. Deutschmann, F. Behrendt, and J. Warnatz, Catal. Today 21 (1994) 461.
[37] I. Lundström, Sens. Actuators A: Phys. 56 (1996) 75.
[38] J. Fogelberg, M. Eriksson, H. Dannetun, and L. G. Petersson, J. Appl. Phys. 78 (1995)988.
[39] J. W. Medlin, A. H. McDaniel, M. D. Allendorf, and R. Bastasz, J. Appl. Phys. 93 (2003) 2267.
[40] L.-G. Ekedahl, M. Eriksson, and I. Lundstrom, Acc. Chem. Res. 31 (1998) 249.
[41] R. C. Hughes, P. A. Taylor, A. J. Ricco, and R. R. Rye, J. Electrochem. Soc. 136 (1989)2653
[42] F. Studt, F. Abild-Pedersen, T. Bligaard, R. Z. Sorensen, C. H. Christensen, and J. K. Norskov, Angew. Chem.-Int. Edit. 47 (2008) 9299.
[43] F. Studt, F. Abild-Petersen, T. Bligaard, R. Z. Sorensen, C. H. Christensen, J. K. Norskov, Science 320 (2008) 1320.

We claim:

1. A method for detecting the presence of acetylene in a gas mixture or a liquid solution comprising at least 1 ppm hydrogen, the method comprising the steps of:
a. providing a first sensor sensitive to hydrogen and acetylene, the sensor being a metal-insulator-semiconductor sensor including a continuous palladium alloy layer;
b. providing a second sensor sensitive to hydrogen and not sensitive to acetylene;
c. providing a signal processing device in electrical communication with the first and second sensors;
d. generating an first electrical signal by exposing the first sensor to the gas mixture or liquid solution, the first sensor being maintained at a selected temperature;
e. generating an second electrical signal by exposing the second sensor to the gas mixture or liquid solution, the second sensor being maintained at the selected temperature;
f. detecting the presence of acetylene through comparing the first and second electrical signals using the signal processing device.

2. The method of claim 1, wherein the palladium alloy is selected from the group consisting of Pd—Ag, Pd—Au, and Pd—Cu.

3. The method of claim 2, wherein the average weight percentage of Ag, Au or Cu in the palladium alloy is 5 wt % to 50 wt %.

4. The method of claim 3, wherein the palladium alloy is a Pd—Ag alloy having 10-40 wt % Ag.

5. The method of claim 1, wherein the gas mixture or liquid solution comprises at least 5 ppm hydrogen and the concentration of acetylene in the gas mixture is less than the concentration of hydrogen.

6. The method of claim 1, wherein the semiconductor is silicon-based and the insulator is silicon dioxide.

7. The method of claim 6, wherein the selected temperature is from 50° C. to 100° C.

8. The method of claim 1, wherein the metal-insulator-semiconductor sensor of step a) is a capacitance sensor comprising a layer of the insulating material, a layer of the palladium alloy attached to one side of the layer of the insulating material and a layer of the semiconducting material attached to the other side of the layer of the insulating material and the electrical signal provided to the signal processing device in step d) is the voltage to maintain a constant capacitance.

9. The method of claim 8, wherein the second sensor is also a metal-insulator-semiconductor sensor.

10. The method of claim 1, wherein the gas mixture or liquid solution does not include a substantial amount of oxygen

11. The method of claim 1, wherein the gas mixture or liquid solution includes a constant concentration of oxygen.

12. A method for determining the concentration of acetylene in a gas mixture or a liquid solution comprising at least 1 ppm hydrogen, the method comprising the steps of:
a. providing a first sensor sensitive to hydrogen and acetylene, the sensor being a metal-insulator-semiconductor sensor including a continuous palladium alloy layer;
b. providing a second sensor sensitive to hydrogen and not sensitive to acetylene;
c. providing a signal processing device in electrical communication with the first and second sensors;
d. generating an first electrical signal by exposing the first sensor to the gas mixture or liquid solution, the first sensor being maintained at a selected temperature;
e. generating an second electrical signal by exposing the second sensor to the gas mixture or liquid solution, the second sensor being maintained at the selected temperature;
f. determining the hydrogen concentration in the gas mixture or liquid solution using the signal processing device and a predetermined relationship between the second electrical signal and hydrogen concentration; and
g. determining the concentration of acetylene in the gas mixture or liquid solution using the signal processing device and a predetermined relationship between the first signal and the acetylene concentration for the hydrogen concentration determined in step f).

13. The method of claim 12, wherein the palladium alloy is selected from the group consisting of Pd—Ag, Pd—Au, and Pd—Cu.

14. The method of claim 13, wherein the average weight percentage of Ag, Au or Cu in the palladium alloy is 5 wt % to 50 wt %.

15. The method of claim 14, wherein the palladium alloy is a Pd—Ag alloy having 10-40 wt % Ag.

16. The method of claim 12, wherein the gas mixture or liquid solution comprises at least 5 ppm hydrogen and the concentration of acetylene in the gas mixture is less than the concentration of hydrogen.

17. The method of claim 12, wherein the semiconductor is silicon-based and the insulator is silicon dioxide.

18. The method of claim 17 wherein the selected temperature is from 50° C. to 100° C.

19. The method of claim 12, wherein the metal-insulator-semiconductor sensor of step a) is a capacitance sensor comprising a layer of the insulating material, a layer of the palladium alloy attached to one side of the layer of the insulating material and a layer of the semiconducting material attached to the other side of the layer of the insulating material and the electrical signal provided to the signal processing device in step d) is the voltage to maintain a constant capacitance.

20. The method of claim 19, wherein the second sensor is also a metal-insulator-semiconductor sensor.

21. The method of claim 12, wherein the gas mixture or liquid solution does not include a substantial amount of oxygen.

22. The method of claim 12, wherein the gas mixture or liquid solution includes a constant concentration of oxygen.
